(19) United States
(12) Patent Application Publication
(10) Pub. No.: US 2016/0171480 A1
(43) Pub. Date: Jun. 16, 2016

(54) METHODS AND SYSTEMS FOR TRANSFERRING ELECTRONIC MONEY

(71) Applicant: VISA INTERNATIONAL SERVICE ASSOCIATION, San Francisco, CA (US)

(72) Inventors: Alan Joseph O'Regan, Cape Town (ZA); Horatio Nelson Huxham, Cape Town (ZA); Tara Anne Moss, Cape Town (ZA); Hough Arie Van Wyk, Cape Town (ZA)

(21) Appl. No.: 14/904,759

(22) PCT Filed: Aug. 20, 2014
(86) PCT No.: PCT/IB2014/063988

§ 371 Date: Jan. 13, 2016

(30) Foreign Application Priority Data
Aug. 21, 2013 (ZA) 2013/06278

(51) Int. Cl. G06Q 20/32; G06Q 20/36

(52) U.S. Cl. CPC G06Q 20/3227; G06Q 20/3674; G06Q 20/3676; G06Q 2220/00

(57) ABSTRACT

Methods and systems for transferring electronic money from a first mobile device of a first user to a receiver are provided. The method performed on the first mobile device includes the steps of: receiving, from the first user, an input representing an amount of electronic money to be transferred from a first electronic purse holding electronic money and associated with the first mobile device; generating, by means of a secure element associated with the first mobile device, an encrypted token representing the amount of electronic money to be transferred, the encrypted token including a unique identifier of the first electronic purse; decrementing an available balance in the first electronic purse by the amount of electronic money to be transferred; and transmitting the encrypted token to the receiver.

### CROSS-REFERENCES TO RELATED APPLICATIONS

This application claims priority to South African Provisional Patent Application No. 2013/06278 filed on 21 Aug. 2013, which is incorporated by reference herein.

### FIELD OF THE INVENTION

The invention relates to methods and systems for transferring electronic money from a mobile device.

### BACKGROUND

Electronic payments made by an average person generally fall into two categories. These are, firstly, in-person payments, and secondly, remote payments. One of the distinguishing features of in-person payments is that a user is in the physical presence of an institution when initializing such a payment, while a corresponding feature of remote payments is that a user is generally located remotely from the institution when initializing such a payment transaction.

Numerous systems have been implemented which aim to limit the amount of physical currency, or cash, used to conduct in-person payment transactions, with a view of improving convenience and safety and security by avoiding the necessity of persons carrying large amounts of cash on their person. One such system currently known may be referred to as an “electronic purse”, which involves contactless payments from an electronic device storing electronic money.

Security concerns are, however, raised in relation to contactless payments, including in relation to the contactless transfer of electronic money. Concerns include the interception of such electronic money by unscrupulous parties, whereby such parties then obtain the electronic money which was intended for another party, and the monetary value thereof is added to the unscrupulous party's electronic purse. Furthermore, stored-value cards are typically anonymous and used in a manner similar to cash, which have led to concerns regarding money laundering through such means.

### BRIEF SUMMARY

In accordance with a first aspect of the present invention there is provided a method for transferring electronic money from a first mobile device of a first user to a receiver, the method being performed on the first mobile device and comprising the steps of:

receiving, from the first user, an input representing an amount of electronic money to be transferred from a first electronic purse holding electronic money and associated with the first mobile device;

generating, by means of a secure element associated with the first mobile device, an encrypted token representing the amount of electronic money to be transferred, the encrypted token including a unique identifier of the first electronic purse;

decrementing an available balance in the first electronic purse by the amount of electronic money to be transferred; and

transmitting the encrypted token to the receiver.

The method may include storing details on the first electronic device including the date and time at which the token has been transferred and/or the amount of electronic money represented by the token.

The first electronic purse may be stored on a memory element and enables transfer of money without communication with a remote server for authorization and wherein the transfer of money increments or decrements the available balance in the first electronic purse.

The first mobile device may relay details relating to the transfer of electronic money stored thereon to a financial institution for the purposes of reconciling transactions and accounts.

Further features provide for the receiver to be one of: a second mobile device; an electronic device of a conversion entity capable of converting the value of the token into another format desired by the user; or a point of sale (POS) device of a merchant.

The receiver in the form of a second mobile device may include a memory element for storing details relating to the transfer of electronic money and wherein the the details stored on the second mobile device include the unique identifier. The details stored on the second mobile device may include the date and time at which the token has been transferred and/or the amount of electronic money represented by the token.

According to a second aspect of the present invention there is provided method for transferring electronic money from a first mobile device of a first user to a receiver, the method being performed at a receiving electronic device of the receiver and comprising the steps of: receiving, from the first mobile device of the first user, an encrypted token representing an amount of electronic money removed from an electronic purse associated with the first mobile device, the encrypted token generated by a secure element associated with the first mobile device and including a unique identifier of the electronic purse; and processing the encrypted token.

In one embodiment, the step of processing the encrypted token may include: decrypting, by means of a second secure element associated with the receiving electronic device, the encrypted token; storing, in a memory element associated with the receiving electronic device, the unique identifier; and incrementing an available balance in a second electronic purse associated with the receiving electronic device by the amount represented by the token.

In another embodiment, the step of processing the encrypted token may include: storing, in a memory element associated with the receiving electronic device, the encrypted token; and, in response to a corresponding request of an operator of the receiving electronic device, transmitting the encrypted token to a final receiver. The receiving electronic device may be an electronic device of a conversion entity able to convert the value of the token into a format desired by the first user.

The unique identifier is a globally unique identifier of the first electronic purse. A further feature provides for the unique identifier to be a Globally Unique Identifier (GUID) which is associated with the first secure element, and by means of which the origin of the token can be determined.

According to a third aspect of the present invention there is provided a system for transferring electronic money comprising a first mobile device of a user, the first mobile device including: an input component for receiving an input representing an amount of electronic money to be transferred from a first electronic purse holding electronic money and associated with the first mobile device; a token generating component for generating, by means of a first secure element associated with the first mobile device, an encrypted token representing the amount of electronic money to be transferred, the encrypted token including a unique identifier of the first electronic purse; a decrementing component for decrementing an available balance in the first electronic purse by the amount of electronic money to be transferred; and a transmitting component for transmitting the encrypted token to a receiver.

The first electronic purse is preferably stored on a memory element and enables transfer of money without communication with a remote server for authorization and wherein the transfer of money increments or decrements the available balance in the first electronic purse.

The system may also include a memory element for storing details relating to the transfer of electronic money and associated with the first mobile device. The details stored on the memory element may include the date and time at which the token has been transferred and/or the amount of electronic money represented by the token.

The system may include a transmitting component for transmitting details stored on the memory element to a financial institution for the purposes of reconciling transactions and accounts.

In one embodiment, the receiver is a second mobile device having a second electronic purse associated therewith and a second secure element associated therewith, the second secure element configured to decrypt an encrypted token received from the first mobile device and to add the amount of electronic money represented by the token to the second electronic purse.

In another embodiment, the receiver is an electronic device of a conversion entity capable of converting the value of the token into a format desired by the first user. Further features provide for the conversion entity to be an automatic bank teller machine, a bank branch, an agent representing a financial institution facilitating the operation of a mobile money banking system, or the like.

The receiver may be a point of sale device of a merchant. The point of sale device of a merchant may have a second secure element incorporated therein; the electronic device is configured to decrypt an encrypted token received from the first mobile device; and the value of the token is used for payment of physical goods or services.

A further feature of the invention provides for a token to represent a value equal to a denomination of a banknote or a coin of a currency in which transactions occur in physical currency.

Further features provide for the system to include a memory element for storing details relating to the transfer of electronic money, wherein the memory element is associated with the second mobile device and/or associated with the first mobile device; for the details stored on the first mobile device to include the date and time at which the token was transferred and the amount of electronic money represented by the token; and for the details stored on the second mobile device to include the date and time that the electronic money was transferred, the unique identifier of the first electronic purse contained in the encrypted token as well as the amount of electronic money represented by the token that was transferred.

A still further feature provides for details relating to the transfer of electronic money stored on the first and/or second mobile devices to be relayed to a financial institution for the reconciliation of transactions and accounts held at the financial institution.

According to a fourth aspect of the present invention there is provided a system for receiving electronic money including a receiving electronic device of a receiver, the receiving electronic device including: a receiving component for receiving, from a first mobile device of a first user, an encrypted token representing an amount of electronic money removed from a first electronic purse associated with the first mobile device of the first user, the encrypted token generated by a first secure element associated with the first mobile device of the user and including a unique identifier of the first electronic purse; and a processing component for processing the encrypted token.

In one embodiment, the processing component may include: a decrypting component for decrypting, by means of a second secure element associated with the receiving electronic device, the encrypted token; a memory element for storing the unique identifier; and a incrementing component for incrementing an available balance in a second electronic purse associated with the receiving electronic device by the amount represented by the token.

In another embodiment, the processing component may include: a memory element associated with the receiving electronic device for storing the encrypted token; and a transmitting component for transmitting the encrypted token to a final receiver in response to a corresponding request of an operator of the electronic device of the receiver.

The receiving electronic device may be an electronic device of a conversion entity able to convert the value of the token into a format desired by the first user.

According to a fifth aspect of the present invention there is provided a computer program product for transferring electronic money, the computer program product comprising a computer readable storage medium having computer-readable program code embodied therewith, the computer-readable program code configured to: receiving, from the first user, an input representing an amount of electronic money to be transferred from a first electronic purse holding electronic money and associated with the first mobile device; generating, by means of a secure element associated with the first mobile device, an encrypted token representing the amount of electronic money to be transferred, the encrypted token including a unique identifier of the first electronic purse; decrementing an available balance in the first electronic purse by the amount of electronic money to be transferred; and transmitting the encrypted token to the receiver.

According to a sixth aspect of the present invention there is provided a computer program product for transferring electronic money, the computer program product comprising a computer readable storage medium having computer-readable program code embodied therewith, the computer-readable program code configured to: receiving, from the first mobile device of the first user, an encrypted token representing an amount of electronic money removed from an electronic purse associated with the first mobile device, the encrypted token generated by a secure element associated with the first mobile device and including a unique identifier of the electronic purse; and processing the encrypted token.

In order for the invention to be more fully understood, implementations thereof will now be described with reference to the accompanying drawings

### BRIEF DESCRIPTION OF THE DRAWINGS

FIG. 1 is a schematic illustration of an embodiment of a system for transferring electronic money according to the invention;

FIG. 2A is a flow diagram of an embodiment of a first aspect of a method according to the invention;

FIG. 2B is a flow diagram of an embodiment of a second aspect of a method according to the invention;

FIG. 3A is a schematic illustration of a first embodiment of a system for transferring electronic money according to the invention;

FIG. 3B is a flow diagram of a method of transferring electronic money according to the first embodiment of FIG. 3A;

FIG. 4 is a schematic illustration of a second embodiment of a system for transferring electronic money according to the invention;

FIG. 5A is schematic illustration of a third embodiment of a system for transferring electronic money according to the invention;

FIG. 5B is a flow diagram of a method of transferring electronic money according to the embodiment of FIG. 5A;

FIG. 6A is a schematic illustration of a fourth embodiment of a system for transferring electronic money according to the invention;

FIG. 6B is a flow diagram of a method of transferring electronic money according to the embodiment of FIG. 6A;

FIG. 7A is a flow diagram of an aspect of a method of receiving electronic money according to the invention;

FIG. 7B is a flow diagram of an aspect of a method of receiving electronic money according to invention;

FIG. 8 illustrates a mobile device that may be used in embodiments of the invention; and

FIG. 9 illustrates an example of a computing device in which various aspects of the disclosure may be implemented.

### DETAILED DESCRIPTION

Methods and systems for the transfer of electronic money are provided. A mobile device is configured to receive an input from a user, which indicates an amount of electronic money that the user wishes to transfer from an electronic purse associated with the mobile device. The mobile device then generates, by means of a secure element or hardware security module associated with the mobile device, an encrypted token representing this value of electronic money. The token includes a unique identifier of the electronic purse. The available balance in the electronic purse is then decremented by the amount of electronic money to be transferred. The encrypted token is transferred to a receiver for onward processing by the receiver or a further entity.

Electronic purses are typically located in a memory element of or associated with mobile electronic devices and may hold, amongst other things, an amount of electronic money. Electronic money is stored in a memory unit in the form of binary-coded data. This may be referred to as a stored-value system, often found in the form of stored-value cards. Stored-value cards are cards on which a monetary value is stored which is not externally recorded in an account. The monetary value thus operates as electronic money. A selected amount of the electronic money may then be transferred to another user or entity, typically a merchant, by any means suitable for in-person transfer of information, such as near-field communication (NFC) technology.

The mobile device of the consumer may be any electronic communications device capable of communicating over a communications network, such as a cellular communications network or the Internet. The term should be interpreted to specifically include all mobile or cellular phones, including so-called “feature phones” and smartphones, and may also include other electronic devices such as computers, laptops, handheld personal computers, personal digital assistants, tablet computers, and the like.

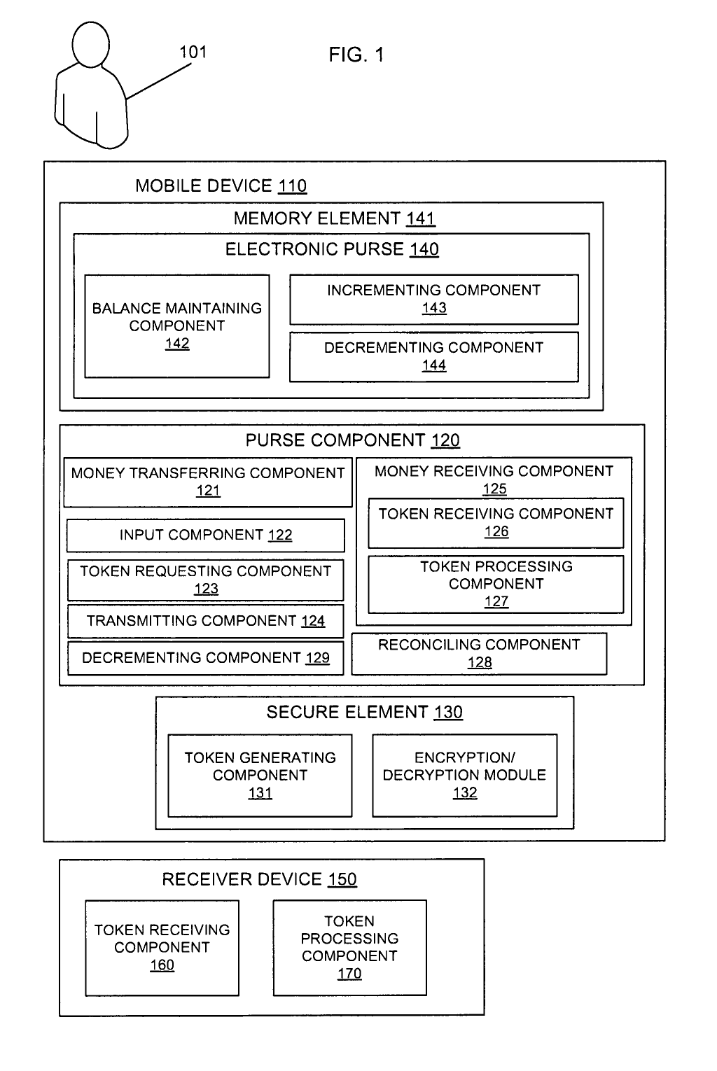

Referring to FIG. 1 a block diagram shows an example embodiment of the described system for transferring electronic money.

The system (100) includes a mobile device (110) of a first user (101). The mobile device (110) includes a electronic purse (140) which is associated with the mobile device (110) and stored on a memory element (141) of the mobile device (110). The electronic purse (140) stores electronic money, similar to the way in which a physical purse stores physical currency.

The electronic purse (140) operates in a similar way to a physical purse, with the amount of money available for spending (the available balance) increasing and decreasing as money is added to the purse or as money is removed from the purse, typically by spending it. The electronic purse (140) includes a balance maintaining component (142), an incrementing component (143), and a decrementing component (144). The electronic purse (140) includes a unique identifier, for example in the form of a globally unique identifier (GUID).

It should be noted that electronic money is able to be traded without the need to be directly or immediately connected to an institution hosting a financial account of a user. Electronic money is used in a manner similar to cash, in that it is deemed not to form part of a user's financial account, but rather as money “drawn” from such an account.

The mobile device (110) has a secure element (130) associated with it. The secure element (130) may take various forms as described below but generally includes a secure storage and execution environment for sensitive data and processing. The secure element (130) of the described system includes a token generating component (131) and an encryption/decryption module (132).

The secure element (130) may be integral to the mobile device (110) in the form of a built-in secure element. Alternatively, the secure element (130) may be disposed within a micro secure digital (SD) or similar card form factor which is placed in a micro SD card slot of the mobile device (110).

As a further alternative, the secure element (130) may be disposed within a communication component of the mobile device (110), such as a universal integrated circuit card (UICC).

It is also anticipated that in some embodiments the secure element (130) may be disposed in an expansion device which may be connected to a mobile device (110) or alternatively disposed within, for example a label, tray or card which is then placed in between a UICC and a UICC interface of the mobile device (110) such that the secure element can intercept and appropriately process any communication sent between the UICC and the mobile device (110) and consequently, between the mobile device (110) and a mobile communication network.

It is further anticipated that the secure element (130) may be a cloud-based secure element using host card emulation (HCE) which enables network-accessible storage external to the mobile device (110) with an application on the mobile device (110) configured to emulate the card functions.

In some embodiment, the secure element (130) may be a hardware security module (HSM). An HSM is different from electronic devices that may solely use software to encrypt communications between an electronic device and a target device or system. An electronic device that solely uses software to encrypt communications may comply with only a security level 1 of the Federal Information Processing Standard 140-2 (FIPS 140-2), which provides only a minimum level of security to protect sensitive information. In contrast, the HSM within an electronic device or controller is compliant with at least a security level 2 of the FIPS 140-2 standard. More preferably, the HSM within the electronic device or controller is compliant with security level 3 or level 4 of FIPS 140-2.

The HSM uses hardware to encrypt data instead of solely performing the encryption in software. The HSM provides enhanced protection over software encryption technologies. For example, the HSM provides secure key management to generate cryptographic keys, sets the capabilities and security limits of keys, implements key backup and recovery, prepares keys for storage and performs key revocation and destruction. In some embodiments, the HSM is implemented as a dual processor device that includes a secure processor with storage and a public processor with storage. The HSM may also include a physical or logical separation between interfaces that are used to communicate critical security parameters and other interfaces that are used to communicate other data. The HSM can also provide a tamper-proof mechanism that provides a high risk of destroying the HSM and the cryptographic keys stored therein, if any attempt is made to remove or externally access the HSM.

In one embodiment, the electronic purse (140) may be stored in the secure element (130). Alternatively, the electronic purse (140) may be provided in a separate memory element (141). The memory element (141), for example, a non-volatile memory unit, stores details relating to transfers of electronic money which has taken place. Details may include the amount of money that has been transferred, the date and time on which the transfer has occurred, or the like.

The mobile device (110) may include a purse component (120) for the electronic purse (140) for receiving user input and displaying instructions and confirmations relating to the electronic purse (140) and coordinating processing of tokens relating to the electronic purse (140).

The purse component (120) may include a money transferring component (121) having an input component (122) for receiving user instructions including an input representing an amount of electronic money to be transferred from the electronic purse (140). The input component (122), for example, a keypad or touch screen of the mobile device (110), is capable of receiving an input from a user of the mobile device which indicates what amount of electronic money is to be transferred from the electronic purse (140) which is associated with the mobile device (110).

The purse component (120) may include a token requesting component (123) which may issue a request to the secure element (130) to generate and encrypt a token including the amount of money to be transferred. The token generating component, for example, a central processing unit, is capable of generating an encrypted token by means of the secure element (130). The encrypted token includes a global unique identifier of the electronic purse (140).

A decrementing component (129) of the purse component (120) decrements the available balance in the electronic purse (140) with the amount of electronic money represented by the encrypted token.

The encrypted token may be provided to the purse component (120) for transmitting by a transmitting component (124). The transmitting component (124), in one embodiment an NFC module, transmits the token to a receiver device (150).

Alternatively, in some embodiments the secure element (130) may transmit the encrypted token directly from the secure element (130).

The encrypted token may be transmitted to a receiver device (150) where it is processed. The processing may take various different forms which are described in detail in the later figures.

The purse component (120) may also include a money receiving component (125) providing functionality when the mobile device (110) receives a money transfer from another user. The money receiving component (125) includes a token receiving component (126) and a token processing component (127). The token processing component (127) may forward a received encrypted token to the secure element (130) for processing and incrementing of the electronic purse (140).

The purse component (120) may include a reconciling component (128) for relaying details relating to the transfer of electronic money to or from the electronic purse (140) to a financial institution for reconciling transactions and accounts. Details stored in the memory element (141) for the electronic purse (140) may be relayed to a financial institution at a later point in time, which may assist the financial institution with reconciling accounts and transactions perform utilizing the system, as well as allow the financial institution to track the use of electronic money.

The encrypted token represents the amount of electronic money to be transferred and includes a unique identifier of the electronic purse (140).

The system (100) includes a receiver device (150). The receiver device (150) includes a token receiving component (160) and a token processing component (170). In this embodiment, a generalized receiver device (150) is described with further details of example embodiments provided in later figures. In particular, the receiver device (150) may be a second mobile device, an automated teller machine (ATM), or a point-of-sale (POS) device of a merchant. The receiver device (150) may decrypt the encrypted token or may store and forward the encrypted token.

The methods and systems described in this specification allow the transfer of electronic money to take place without the need for connection to a financial institution. However, the inclusion of a unique identifier, typically a GUID, of the electronic purse in the token which represents the electronic money allows details relating to the token to be stored for relay to a financial institution at a later stage. By obtaining details of the transfer of electronic money, as well as the GUID's associated with those transfers, a financial institution is able to reconcile transactions and accounts. A GUID will be unique to a specific electronic purse, which means that transactions will be able to be traced back to a specific user. This may allow for a way in which electronic money transactions can be, at least partially, monitored, and the flow of electronic money can be tracked.

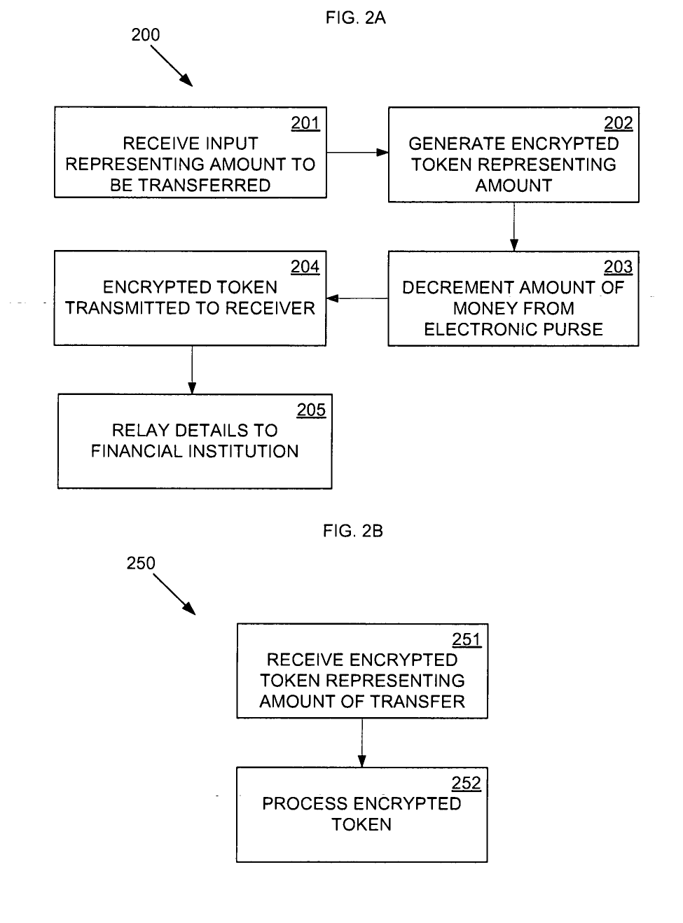

Referring to FIG. 2A, a flow diagram (200) shows a method as carried out at a first mobile device (110) for transferring electronic money.

The method includes receiving (201), from the first user, an input representing an amount of electronic money to be transferred from a first electronic purse holding electronic money and associated with the first mobile device.

The method then includes generating (202), by means of a secure element associated with the first mobile device, an encrypted token representing the amount of electronic money to be transferred. The encrypted token includes a unique identifier of the first electronic purse.

An available balance in the first electronic purse is decremented (203) by the amount of electronic money to be transferred and the encrypted token is transmitted (204) to the receiver device.

The method may also include the first mobile device relaying (205) details relating to the transfer of electronic money stored thereon to a financial institution for the purposes of reconciling transactions and accounts. Such relaying may take place at a later time than the transmitting of the token.

Referring to FIG. 2B, a flow diagram (250) shows a method as carried out at a receiver device (150) for receiving electronic money.

The method may receive (251), from the first mobile device of the first user, an encrypted token representing an amount of electronic money removed from an electronic purse associated with the first mobile device, the encrypted token generated by a secure element associated with the first mobile device and including a unique identifier of the electronic purse.

The method may include processing (252) the encrypted token. The processing may take various forms as described in later embodiments.

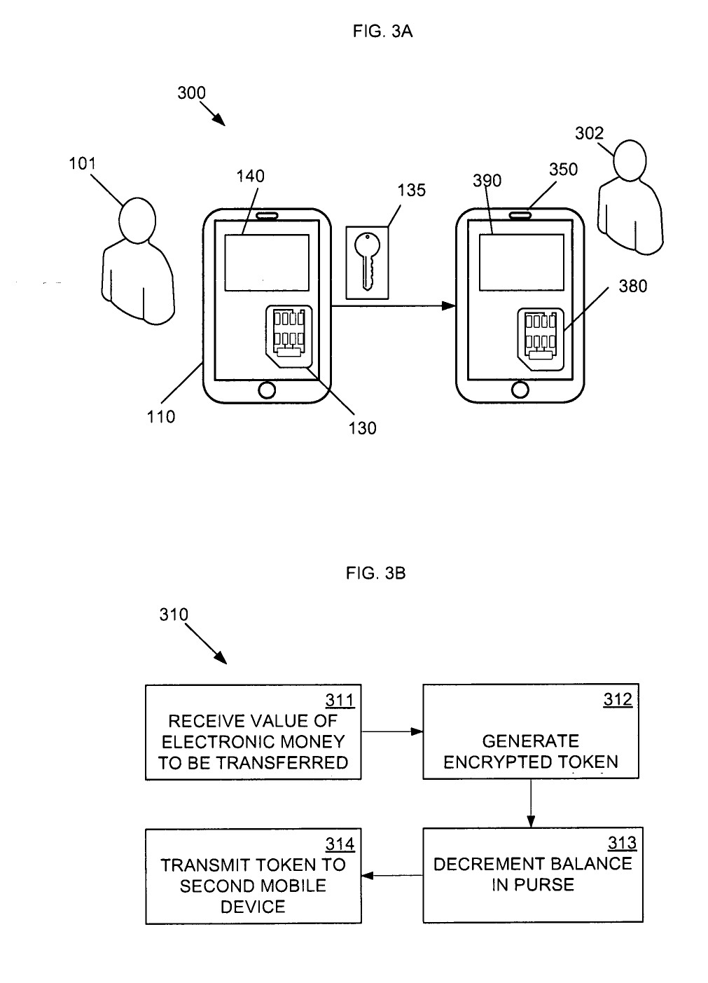

FIG. 3A illustrates a first specific embodiment of a system (300) for transferring electronic money. The system (300) comprises a first user (101), who has a first mobile device (110) as described in relation to FIG. 1. The first mobile device (110) has a first secure element (130) associated with it. In this embodiment, the first secure element (130) is a hardware security module (HSM) incorporated in the first mobile device (110). A first electronic purse (140) is associated with and stored on the first mobile device (110).

An encrypted token (135) is generated and transmitted from the first mobile device (110) to the second mobile device (350) thereby transferring an amount from the first electronic purse (140) to the second electronic purse (390). Using local secure elements (130, 380), the encrypted token (135) can be generated for a specific amount and transferred and decrypted and added to a second electronic purse (390) without need to contact a backend server.

In this embodiment, the receiver device is a second mobile device (350) of a second user (302), and which has a second secure element (380) in the form of an HSM incorporated therein. A second electronic purse (390) is associated with the second mobile device (350).

The second mobile device (350) may have the same components and functionality as the first mobile device (110) described in relation to FIG. 1 including the money receiving component (125).

FIG. 3B is a flow diagram (310) which illustrates the method of operation of the system of FIG. 3A, as performed on the first mobile device (110). In a first step (311), the first mobile device (110) receives, from the first user (101), an input which represents an amount of electronic money to be transferred from the first electronic purse to the second electronic purse (390).

In a next step (312), the first mobile device generates, by means of the secure element (130), an encrypted token (135) which represents the amount of electronic money to be transferred. The token also includes a unique identifier, in the present embodiment a globally unique identifier (GUID), of the electronic purse. The inclusion of the GUID allows the tracking of the origin of the electronic money to the electronic purse which has transmitted the electronic money.

In a next step (313), the balance of the first electronic purse (140) is decreased by the amount of electronic money represented by the encrypted token (135). In final step (314), the encrypted token is transmitted to the second mobile device (350). In the present embodiment, transmission occurs via near-field communication (NFC) technology means, however, any suitable method transfer method may be used, including Wi-Fi, Bluetooth, or the like.

In the present embodiment, the encrypted token (135) is decrypted by the second secure element (380), and the value represented by the token is added to the second electronic purse (390) contained on the second mobile device (350). The unique identifier is stored in a memory element on the second mobile device, typically a memory element on the secure element (380), in combination with other details relating to the transfer of electronic money. These details typically include a date and time on which the token was generated or transmitted, as well as a date and time at which the token was received or decrypted. The recording of such details relating to the token allows the mobile device to relay these details to a financial institution which facilitates the operation of the system, for the purpose of the reconciliation of transactions and accounts. Other details may include amounts of electronic money transferred, geographic locations at which the electronic money has been transferred, or the like.

The first mobile device may also store details regarding the transfer of electronic money, typically a date and time of generation or of the transmitting of the token. Relaying of these details to a financial institution will further assist in the reconciliation of transactions and accounts.

It should be noted that the relaying of details to a financial institution may occur at a time after the transfer of electronic money has occurred, or at specific times, for example once a month or week, which negates the need for a continuous communication channel with the financial institution during the transfer of electronic money. This allows for transactions to occur in regions which do not have mobile network coverage, with the stored details being relayed to the financial institution at a later stage when the device does in fact have network coverage.

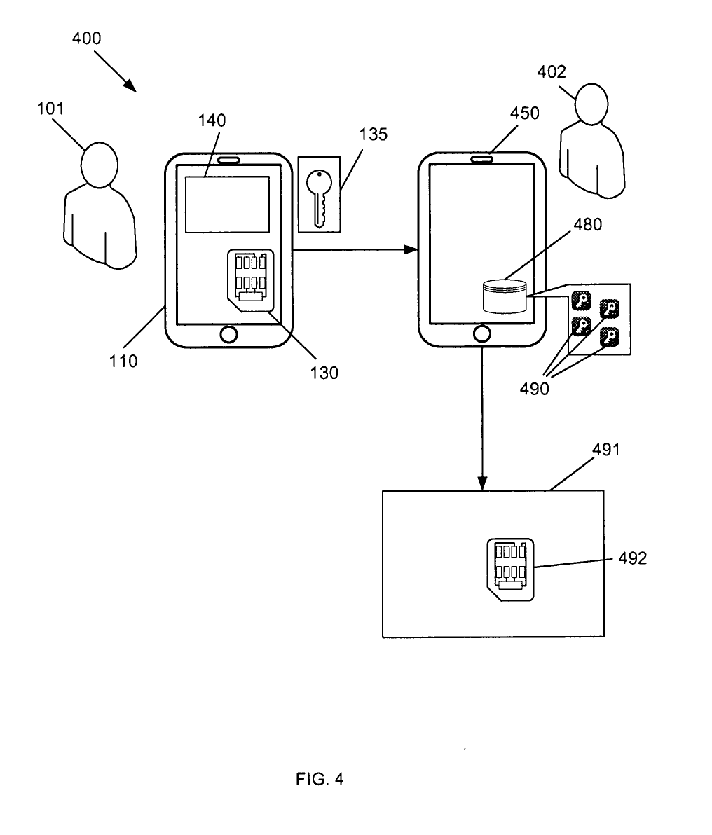

It is foreseen that in some embodiments, the receiver device does not require a secure element. A second embodiment illustrating such a system (400) is shown in FIG. 4 in which the features of the first mobile device (110) are as described with respect to FIG. 1. The steps of the method as illustrated and described with reference to FIG. 3B remain the same.

In this embodiment, the second mobile device (450) is not equipped with or associated with a secure element, but merely stores a received encrypted timestamp in a memory element (480). A second user (402) of the second mobile device (450) transmits the encrypted tokens (490) to a final receiver. In the present embodiment, the final receiver is an automatic bank teller machine (ATM) (491). The ATM (491) has a second secure element (such as an HSM) (492) incorporated therein.

The ATM decrypts the encrypted tokens (490) received using the second secure element (492), and then handles the values as per the user's request. The value of the tokens may be presented to the second user (402) in physical currency, may be added to a financial account of the second user (402) held at a financial institution, may add the value of the tokens to an electronic purse of the user, or may provide the user with the value in any other acceptable way.

It should be noted that the final receiver may also be a financial institution including a bank branch, an agent of a mobile banking institution, or the like.

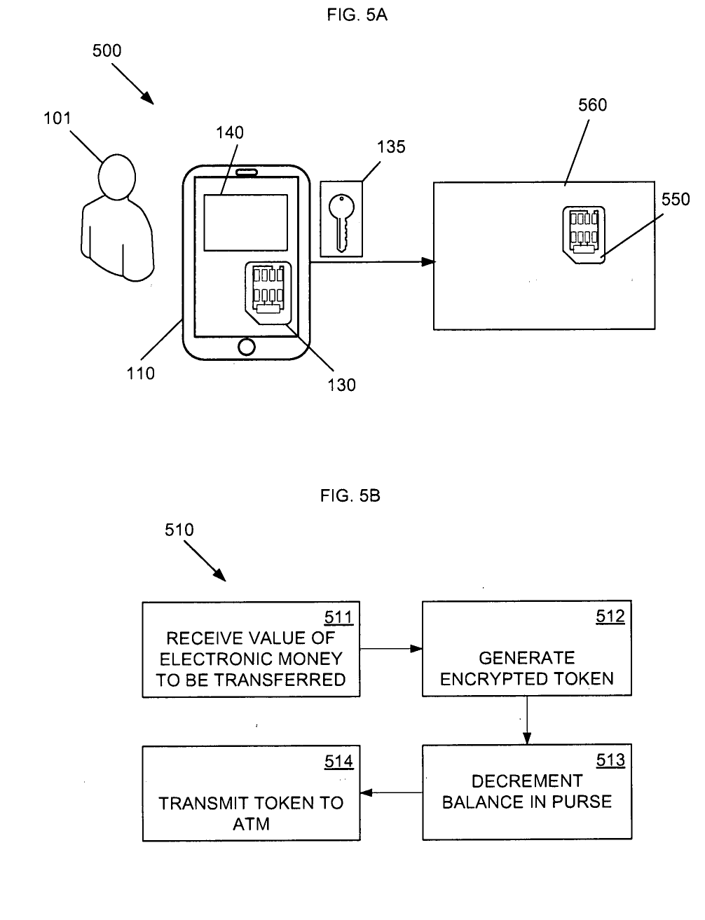

FIG. 5A illustrates a third embodiment of a system (500) for transferring electronic money. In this embodiment, the receiver is a conversion entity, in the present embodiment an ATM (560). The conversion entity is able to convert an encrypted token into another form representing the value of the token.

The system comprises a user (101), as well as the user's mobile device (110). A first secure element (130) is incorporated or associated with the mobile device, and an electronic purse (140) is associated with the mobile device. A second secure element in the form of an HSM (550) is incorporated in the ATM (560).

FIG. 5B illustrates a flow diagram (510) of a method of operation of the system of FIG. 5A.

The steps performed in the method are substantially similar to the method described with reference to FIG. 3B. In a first step (511), the mobile device (110) receives, from the user (101), an input which represents an amount of electronic money to be transferred from the electronic purse.

In a next step (512), the mobile device generates, by means of the secure element (130), an encrypted token (135) which represents the amount of electronic money to be transferred. The token also includes a unique identifier, in the present embodiment a globally unique identifier (GUID) of the electronic purse.

In a next step (513), the balance of the first electronic purse (140) is decreased by the amount of electronic money represented by the encrypted token (135). In final step (514), the encrypted token is transmitted to the ATM (560), in this embodiment again via NFC technology.

From thereon, the ATM (560) decrypts the encrypted token with the second secure element in the form of an HSM (550), and may perform a number of actions afterwards. Firstly, the ATM may present the first user (101) with the value of the token in physical currency. Alternatively, the ATM may add the value represented by the token to a financial account which is held by a financial institution affiliated with or comparable with the ATM. Such use of the system and method will typically be for a user who wishes to convert electronic money on his or her electronic purse to actual money, when, for example, the value in their electronic purse has reached an unnecessarily high level, possibly due to a number of transfers received from other users and added to their own electronic purse by. Any other suitable method of providing the user with the value of the token may be used as well.

The receiver device, in the embodiment of FIG. 5A in the form of an ATM, may also be a bank branch, an agent representing a financial institution facilitating the operation of a mobile money banking system, or any other sufficient conversion entity able to convert a user's electronic money into a currently available form of money.

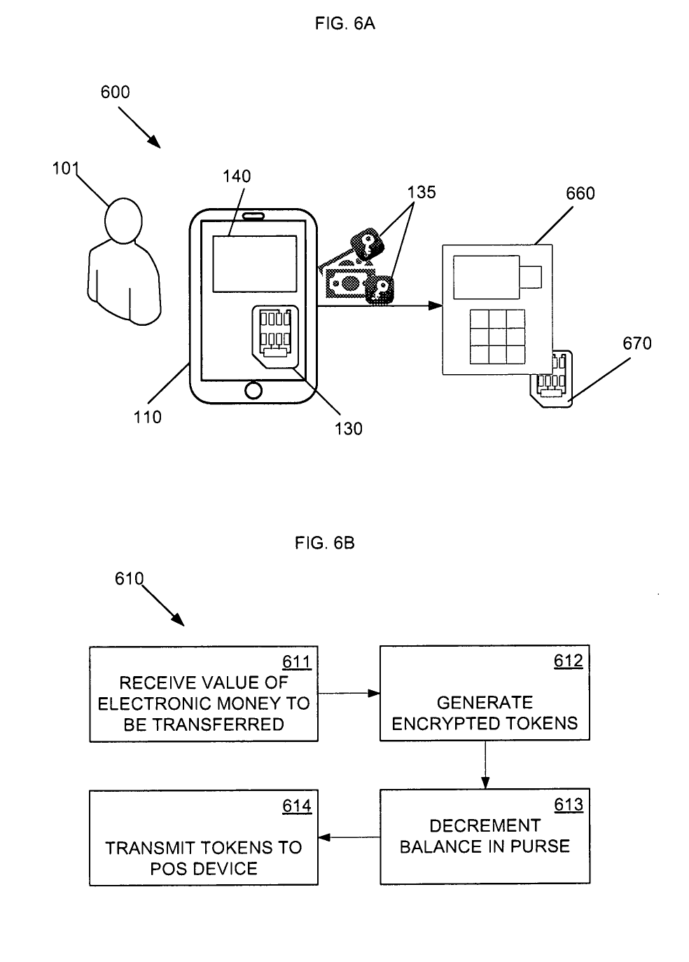

FIG. 6A illustrates a fourth embodiment of the system and method. In this system (600) the receiver is a point of sale (POS) device (660) of a merchant. The system comprises a user (101), as well as the user's mobile device (110). A first secure element (130) is incorporated or associated with the mobile device, and an electronic purse (140) is associated with the mobile device. A second secure element in the form of an HSM (670) is incorporated in the POS device (660) of a merchant.

FIG. 6B illustrates a flow diagram (610) of a method of operation of the system of FIG. 6A.

The steps performed in the method are substantially similar to the method described with reference to FIG. 3B and FIG. 5B. In a first step (611), the mobile device (110) receives, from the user (101), an input which represents an amount of electronic money to be transferred from the electronic purse (140).

In a next step (612), the mobile device generates, by means of the secure element (130), a number of encrypted tokens (135) which tokens are equal in value to or greater than the amount of electronic money to be transferred. The tokens each include a unique identifier, in the present embodiment a globally unique identifier (GUID) of the electronic purse. In the present embodiment, the value of each token corresponds to a denomination of banknotes in circulation, for example $1, $5, $10 or the like, depending on the currency in use in the country in which the method is performed. A number of tokens will be generated by the first secure element (130) in response to a payment request, so that a minimum number of tokens equal to or greater than the amount to be paid.

When, for example, the user wishes to make a payment for $35.80, tokens of values of $20, $10, $5 and $1 may be generated by the first secure element (130).

In a next step (613), the balance of the first electronic purse (140) is decreased by the amount of electronic money represented by the encrypted tokens (135), in the present example $36.00. In final step (614), the encrypted tokens are transmitted to the POS device (660), in this embodiment again via NFC technology.

The second secure element in the form of an HSM (670) decrypts the tokens (135), and determines that an amount of $36.00 has been received. The merchant may then provide the user (101) with physical coins equaling 20 cents, the change of the transaction.

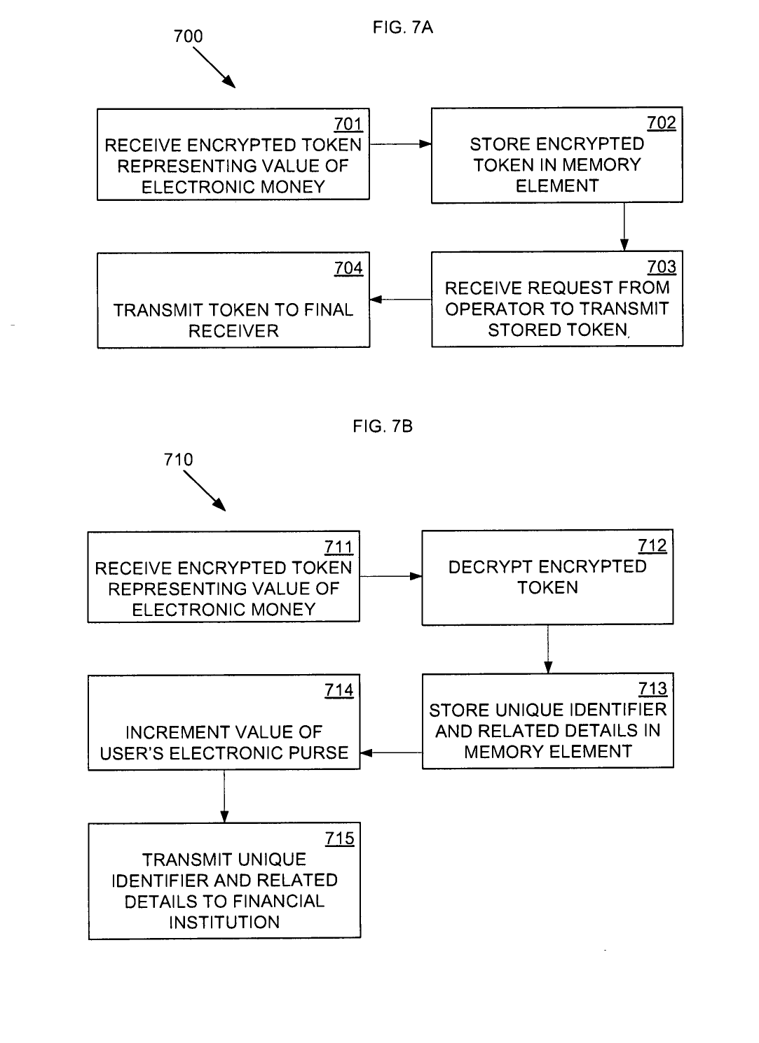

Flow diagrams illustrating two embodiments of the operation of a further aspect of the method of receiving electronic money are illustrated in FIG. 7A and FIG. 7B. The method will be described as it is performed on a second mobile device (450) of a second user (402) as described with reference to FIG. 4.

In a first step (701), the second mobile device (450) receives an encrypted token (135) from a first mobile device (110). The encrypted token is generated in the same manner as previously described with reference to FIG. 4.

In a next step (702), the encrypted token is stored in a memory element (480) of the second mobile device. The second user (402) then indicates, in a next step (703), that he or she wishes to transmit the encrypted token (135) to a final receiver. In a final step (704), the encrypted token is transmitted to the final receiver, in the present embodiment an ATM (491).

The ATM (491) decrypts the encrypted token using an HSM (492) incorporated therein. The second user (402) then chooses how he or she would like to receive the value of the token, for example, if he would like to receive the value represented by the token in physical currency, if he or she would like the value to be added to an account of theirs held at a financial institution associated with the ATM, if he or she would like the value to be added to their electronic purse, or the like.

The final receiver may, of course, also be another element of a financial institution, for example a bank branch, an agent in a mobile money system, or the like.

A flow diagram illustrating a second embodiment of the operation of a method for receiving electronic money (710) is illustrated in FIG. 7B. The method will be described as it is performed on a second mobile device (350) of a second user (302) as described with reference to FIG. 3A.

In a first step (711), the second mobile device (350) receives an encrypted token (135) from a first mobile device (110), the encrypted token representing an amount of electronic money and including a unique identifier of an electronic purse (140) associated with the first mobile device (110) and from which the electronic money has been removed. The encrypted token is generated in the same manner as previously described with reference to FIG. 3A.

In a next step (712), the second mobile device (350) decrypts the encrypted token, and in a next step (713), the unique identifier is stored in a memory element of the second mobile device. Other related transaction details may also be stored in memory, including a date and time at which the transfer of electronic money has occurred.

In a next step (714), a balance of an electronic purse associated with the second mobile device (350) is incremented by the value of electronic money represented by the token (135) received. The second user is then able to transact using this electronic money as he or she normally would.

In a final step (715), unique identifiers and related transaction details may be relayed to a financial institution facilitating the operation of the system as herein described. This allows the financial institution to reconcile transactions that have taken place with accounts held by it, as well as account held at other affiliated financial institutions.

It should be noted that the final step (715) of relaying details to the financial institution, may be performed a significant time after the previous step (714) of incrementing the value of the second electronic purse's balance has been performed. This allows a user to receive electronic money, and use the money in his or her purse, while not in a location where they are able connect to the financial institution. The relaying of details may then occur when they are again in a location where they are able to connect to a financial institution. Furthermore, a user may also wish to only relay the details over a specific network, for example their home Wi-Fi network. In such an instance, the user can receive electronic money, and the system can be set up to only transmit the details to the financial institution when the user is connected to their home Wi-Fi network again.

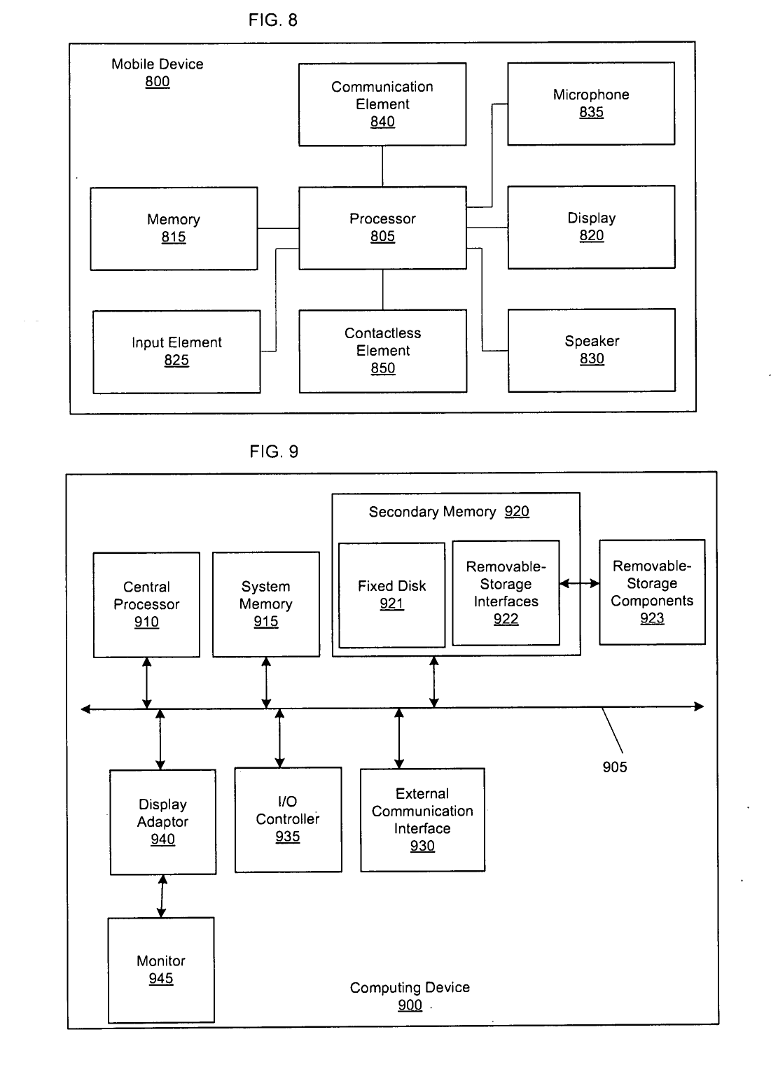

FIG. 8 shows a block diagram of a mobile device (800) that may be used in embodiments of the disclosure. The mobile device (800) is a communication device and may be a cell phone, a feature phone, a smart phone, a satellite phone, or a computing device having a phone capability.

The mobile device (800) may include a processor (805) (e.g., a microprocessor) for processing the functions of the mobile device (800) and a display (820) to allow a user to see the phone numbers and other information and messages. The mobile device (800) may further include an input element (825) to allow a user to input information into the device (e.g., input buttons, touch screen, etc.), a speaker (830) to allow the user to hear voice communication, music, etc., and a microphone (835) to allow the user to transmit his or her voice through the mobile device (800).

The processor (810) of the mobile device (800) may connect to a memory (815). The memory (815) may be in the form of a computer-readable medium that stores data and, optionally, computer-executable instructions.

The mobile device (800) may also include a communication element (840) for connection to communication channels (e.g., a cellular telephone network, data transmission network, Wi-Fi network, satellite-phone network, Internet network, Satellite Internet Network, etc.). The communication element (840) may include an associated wireless transfer element, such as an antenna.

The communication element (840) may include a subscriber identity module (SIM) in the form of an integrated circuit that stores an international mobile subscriber identity and the related key used to identify and authenticate a subscriber using the mobile device (800). One or more subscriber identity modules may be removable from the mobile device (800) or embedded in the mobile device (800).

The mobile device (800) may further include a contactless element (850), which is typically implemented in the form of a semiconductor chip (or other data storage element) with an associated wireless transfer element, such as an antenna. The contactless element (850) may be associated with (e.g., embedded within) the mobile device (800) and data or control instructions transmitted via a cellular network may be applied to the contactless element (850) by means of a contactless element interlace (not shown). The contactless element interface may function to permit the exchange of data and/or control instructions between mobile device circuitry (and hence the cellular network) and the contactless element (850).

The contactless element (850) may be capable of transferring and receiving data using a near field communications (NFC) capability (or near field communications medium) typically in accordance with a standardized protocol or data transfer mechanism (e.g., ISO 14443/NFC). Near field communications capability is a short-range communications capability, such as radio-frequency identification (RFID), Bluetooth, infra-red, or other data transfer capability that can be used to exchange data between the mobile device (800) and an interrogation device. Thus, the mobile device (800) may be capable of communicating and transferring data and/or control instructions via both a cellular network and near field communications capability.

The data stored in the memory (815) may include: operation data relating to the operation of the mobile device (800), personal data (e.g., name, date of birth, identification number, etc.), financial data (e.g., bank account information, a bank identification number (BIN), credit or debit card number information, account balance information, expiration date, loyalty provider account numbers, etc.), transit information (e.g., as in a subway or train pass), access information (e.g., as in access badges), etc. A user may transmit this data from the mobile device (800) to selected receivers.

The mobile device (800) may be, amongst other things, a notification device that can receive alert messages and access reports, a portable merchant device that can be used to transmit control data identifying a discount to be applied, as well as a portable consumer device that can be used to make payments.

FIG. 9 illustrates an example of a computing device (900) in which various aspects of the disclosure may be implemented. The computing device (900) may be suitable for storing and executing computer program code. The various participants and elements in the previously described system diagrams may use any suitable number of subsystems or components of the computing device (900) to facilitate the functions described herein.

The computing device (900) may include subsystems or components interconnected via a communication infrastructure (905) (for example, a communications bus, a cross-over bar device, or a network). The computing device (900) may include at least one central processor (910) and at least one memory component in the form of computer-readable media.

The memory components may include system memory (915), which may include read only memory (ROM) and random access memory (RAM). A basic input/output system (BIOS) may be stored in ROM. System software may be stored in the system memory (915) including operating system software.

The memory components may also include secondary memory (920). The secondary memory (920) may include a fixed disk (921), such as a hard disk drive, and, optionally, one or more removable-storage interfaces (922) for removable-storage components (923).

The removable-storage interfaces (922) may be in the form of removable-storage drives (for example, magnetic tape drives, optical disk drives, floppy disk drives, etc.) for corresponding removable storage-components (for example, a magnetic tape, an optical disk, a floppy disk, etc.), which may be written to and read by the removable-storage drive.

The removable-storage interfaces (922) may also be in the form of ports or sockets for interfacing with other forms of removable-storage components (923) such as a flash memory drive, external hard drive, or removable memory chip, etc.

The computing device (900) may include an external communications interface (930) for operation of the computing device (900) in a networked environment enabling transfer of data between multiple computing devices (900). Data transferred via the external communications interface (930) may be in the form of signals, which may be electronic, electromagnetic, optical, radio, or other types of signal.

The external communications interface (930) may enable communication of data between the computing device (900) and other computing devices including servers and external storage facilities. Web services may be accessible by the computing device (900) via the communications interface (930).

The external communications interface (930) may also enable other forms of communication to and from the computing device (900) including, voice communication, near field communication, Bluetooth, etc.

The computer-readable media in the form of the various memory components may provide storage of computer-executable instructions, data structures, program modules, and other data. A computer program product may be provided by a computer-readable medium having stored computer-readable program code executable by the central processor (910).

A computer program product may be provided by a non-transient computer-readable medium, or may be provided via a signal or other transient means via the communications interface (930).

Interconnection via the communication infrastructure (905) allows a central processor (910) to communicate with each subsystem or component and to control the execution of instructions from the memory components, as well as the exchange of information between subsystems or components.

Peripherals (such as printers, scanners, cameras, or the like) and input/output (I/O) devices (such as a mouse, touchpad, keyboard, microphone, joystick, or the like) may couple to the computing device (900) either directly or via an I/O controller (935). These components may be connected to the computing device (900) by any number of means known in the art, such as a serial port.

One or more monitors (945) may be coupled via a display or video adapter (940) to the computing device (900).

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. The described operations may be embodied in software, firmware, hardware, or any combinations thereof.

The software components or functions described in this application may be implemented as software code to be executed by one or more processors using any suitable computer language such as, for example, Java, C++, or Perl using, for example, conventional or object-oriented techniques. The software code may be stored as a series of instructions, or commands on a non-transitory computer-readable medium, such as a random access memory (RAM), a read-only memory (ROM), a magnetic medium such as a hard-drive or a floppy disk, or an optical medium such as a CD-ROM. Any such computer-readable medium may also reside on or within a single computational apparatus, and may be present on or within different computational apparatuses within a system or network.

Any of the steps, operations, or processes described herein may be performed or implemented with one or more hardware or software modules, alone or in combination with other devices. In one embodiment, a software module is implemented with a computer program product comprising a non-transient computer-readable medium containing computer program code, which can be executed by a computer processor for performing any or all of the steps, operations, or processes described.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

1. A method for transferring electronic money from a first mobile device of a first user to a receiver, the method being performed on the first mobile device and comprising the steps of:
receiving, from the first user, an input representing an amount of electronic money to be transferred from a first electronic purse holding electronic money and associated with the first mobile device;
generating, by means of a secure element associated with the first mobile device, an encrypted token representing the amount of electronic money to be transferred, the encrypted token including a unique identifier of the first electronic purse;
decrementing an available balance in the first electronic purse by the amount of electronic money to be transferred; and
transmitting the encrypted token to the receiver.

2. The method as claimed in claim 1 including storing details on the first mobile device including the date and time at which the token has been transferred and/or the amount of electronic money represented by the token.

3. The method as claimed in claim 1 wherein the first electronic purse is stored on a memory element and enables transfer of money without communication with a remote server for authorization and wherein the transfer of money increments or decrements the available balance in the first electronic purse.

4. The method as claimed in claim 1 wherein the first mobile device relays details relating to the transfer of electronic money stored thereon to a financial institution for the purposes of reconciling transactions and accounts.

5. The method as claimed in claim 1 wherein the receiver is a second mobile device including a memory element for storing details relating to the transfer of electronic money and wherein the details stored on the second mobile device include the unique identifier.

6. The method as claimed in claim 5 wherein the details stored on the second mobile device include the date and time at which the token has been transferred and/or the amount of electronic money represented by the token.

7. (canceled)

8. (canceled)

9. A method for transferring electronic money from a first mobile device of a first user to a receiver, the method being performed at a receiving electronic device of the receiver and comprising the steps of:
receiving, from the first mobile device of the first user, an encrypted token representing an amount of electronic money removed from an electronic purse associated with the first mobile device, the encrypted token generated by a secure element associated with the first mobile device and including a unique identifier of the electronic purse; and
processing the encrypted token.

10. The method as claimed in claim 9 wherein the step of processing the encrypted token includes: decrypting, by means of a second secure element associated with the receiving electronic device, the encrypted token; storing, in a memory element associated with the receiving electronic device, the unique identifier; and incrementing an available balance in a second electronic purse associated with the receiving electronic device by the amount represented by the token.

11. The method as claimed in claim 9 wherein the step of processing the encrypted token includes: storing, in a memory element associated with the receiving electronic device, the encrypted token; and, in response to a corresponding request of an operator of the receiving electronic device, transmitting the encrypted token to a final receiver.

12. (canceled)

13. (canceled)

14. A system for transferring electronic money comprising a first mobile device of a user, the first mobile device including:
an input component for receiving an input representing an amount of electronic money to be transferred from a first electronic purse holding electronic money and associated with the first mobile device;
a token generating component for generating, by means of a first secure element associated with the first mobile device, an encrypted token representing the amount of electronic money to be transferred, the encrypted token including a unique identifier of the first electronic purse;
a decrementing component for decrementing an available balance in the first electronic purse by the amount of electronic money to be transferred; and
a transmitting component for transmitting the encrypted token to a receiver.

15. The system as claimed in claim 14 wherein the first electronic purse is stored on a memory element and enables transfer of money without communication with a remote server for authorization and wherein the transfer of money increments or decrements the available balance in the first electronic purse.

16. The system as claimed in claim 14 including a memory element for storing details relating to the transfer of electronic money and associated with the first mobile device, the details including the date and time at which the token has been transferred and/or the amount of electronic money represented by the token.

17. (canceled)

18. The system as claimed in claim 14 which includes a transmitting component for transmitting details stored on the memory element to a financial institution for the purposes of reconciling transactions and accounts.

19. The system as claimed in claim 14 wherein the receiver is a second mobile device having a second electronic purse associated therewith and a second secure element associated therewith, the second secure element configured to decrypt an encrypted token received from the first mobile device and to add the amount of electronic money represented by the token to the second electronic purse.

20. The system as claimed in claim 14 wherein the receiver is an electronic device of a conversion entity capable of converting the value of the token into a format desired by the first user.

21. The system as claimed in claim 14 wherein the receiver is a point of sale device of a merchant.

22. The system as claimed in claim 10 wherein the receiver is a receiving electronic device including:
a receiving component for receiving, from the first mobile device of the first user, the encrypted token representing the amount of electronic money removed from a first electronic purse associated with the first mobile device of the first user, the encrypted token generated by the first secure element associated with the first mobile device of the user and including the unique identifier of the first electronic purse; and
a processing component for processing the encrypted token.

23. The system as claimed in claim 22 wherein the processing component includes:
a decrypting component for decrypting, by means of a second secure element associated with the receiving electronic device, the encrypted token;
a memory element for storing the unique identifier; and
an incrementing component for incrementing an available balance in a second electronic purse associated with the receiving electronic device by the amount represented by the token.

24. The system as claimed in claim 22 wherein the processing component includes:
a memory element associated with the receiving electronic device for storing the encrypted token; and
a transmitting component for transmitting the encrypted token to a final receiver in response to a corresponding request of an operator of the electronic device of the receiver.

25. The system as claimed in claim 24 wherein the receiving electronic device is an electronic device of a conversion entity able to convert the value of the token into a format desired by the first user.

26. (canceled)

27. (canceled)
